(19) United States
(12) Patent Application Publication
(10) Pub. No.: US 2011/0143676 A1
(43) Pub. Date: Jun. 16, 2011

(54) DEVICE AND METHOD FOR RECEIVING A SIGNAL IN MILLIMETER WAVEBAND

(75) Inventors: Jong Ho KIM, Daejeon (KR); Young Keun Yoon, Chungbuk (KR); Myoung-Won Jung, Daejeon (KR)

(73) Assignee: ELECTRONICS AND TELECOMMUNICATIONS RESEARCH INSTITUTE, Daejeon (KR)

(21) Appl. No.: 12/914,425

(22) Filed: Oct. 28, 2010

(30) Foreign Application Priority Data
Dec. 16, 2009 (KR) 10-2009-0125230
Feb. 1, 2010 (KR) 10-2010-0009117

(51) Int. Cl. H04B 17/00; H04B 7/24

(52) U.S. Cl. 455/67.11; 455/39

(57) ABSTRACT

Provided is a millimeter waveband signal receiving device and method. The millimeter waveband signal receiving method includes receiving a plurality of millimeter waveband signals via a plurality of paths, selecting a switching path from among the plurality of paths based on the plurality of received millimeter waveband signals, and setting a communication connection to the selected switching path.

### CROSS-REFERENCE TO RELATED APPLICATION(S)

This application claims the benefit of Korean Patent Application Nos. 10-2009-0125230 and 10-2010-0009117, respectively filed on Dec. 16, 2009 and Feb. 1, 2010, in the Korean Intellectual Property Office, the disclosures of which are incorporated herein by references.

### BACKGROUND

1. Field of the Invention

The present invention relates to a millimeter waveband signal receiving device and method, and more particularly, to a millimeter waveband signal receiving device and method that may process a plurality of millimeter waveband signals received via a plurality of paths to effectively cope with a situation where a propagation path is blocked.

2. Description of the Related Art

A millimeter waveband may include sufficient frequency resources and may provide a wide bandwidth and thus, a high speed transmission may be effectively performed. Recently, the millimeter waveband has been commonly used for transmitting a high definition video image.

However, the millimeter waveband may have a great absorption loss due to materials in an atmosphere, and particularly, 60 GHz may have an absorption loss caused by oxygen in the atmosphere. Therefore, the millimeter waveband may be used for communication over a short distance indoors, or communication in a line-of-sight scheme.

FIG. 1 illustrates a conventional millimeter waveband signal transceiving system.

A millimeter waveband signal may be blocked indoors by an object or a person existing in a propagation range, as illustrated in FIG. 1

When the propagation path between a transmitting device 10 and a receiving device 20 is blocked, a communication may be immediately disconnected and thus, data loss may be incurred. The millimeter waveband may be commonly used for high speed and high capacity transmission and thus, may incur a relatively greater amount of data loss.

Although the millimeter waveband may provide a wide bandwidth, a significantly narrow beam width may be commonly used within a line-of-sight range due to a high absorption loss by materials in the atmosphere. In this case, the propagation path can be very limited, and the propagation path may be blocked by obstacles and the like and thus, disconnection of the communication may be expected. However, the millimeter waveband may be utilized without complex extension leads. Accordingly, use of the millimeter waveband has been increasing even though there may exist a probability of the disconnection of the communication incurred by blocking of the propagation path. Therefore, the present invention provides a new device and method for effectively receiving a signal in the millimeter waveband.

### SUMMARY

An aspect of the present invention provides a receiving device for receiving a millimeter waveband signal and a receiving method thereof, the receiving device and the receiving method performing switching of communication connection to another path when a millimeter waveband communication is blocked, and thus, the communication is continuously maintained.

According to an aspect of the present invention, there is provided a millimeter waveband signal receiving device, and the device includes at least one reception antenna to receive, from a transmission antenna, a plurality of millimeter waveband signals via a plurality of paths, and a controller to select, based on the plurality of received millimeter waveband signals, a switching path from among the plurality of paths, to set a communication connection.

According to an aspect of the present invention, there is provided a millimeter waveband signal receiving method, and the method includes receiving a plurality of millimeter waveband signals via a plurality of paths, selecting a switching path from among the plurality of paths based on the plurality of received millimeter waveband signals, and setting a communication connection to the selected switching path.

Additional aspects, features, and/or advantages of the invention will be set forth in part in the description which follows and, in part, will be apparent from the description, or may be learned by practice of the invention.

### EFFECT

According to embodiments, a communication in a millimeter waveband for high speed transmission may be continuously performed without becoming disconnected.

According to embodiments, a communication may be continuously performed by overcoming transmission blocking incurred by an obstacle and the like, using a multi-path.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a conventional millimeter waveband signal transceiving system;

FIG. 2 is a diagram illustrating an example of a process of a receiving device for receiving a millimeter waveband signal according to an embodiment of the present invention;

FIG. 3 is a diagram illustrating a configuration of the receiving device of FIG. 2; and

FIGS. 4 and 5 are flowcharts illustrating a millimeter waveband signal receiving method according to an embodiment of the present invention.

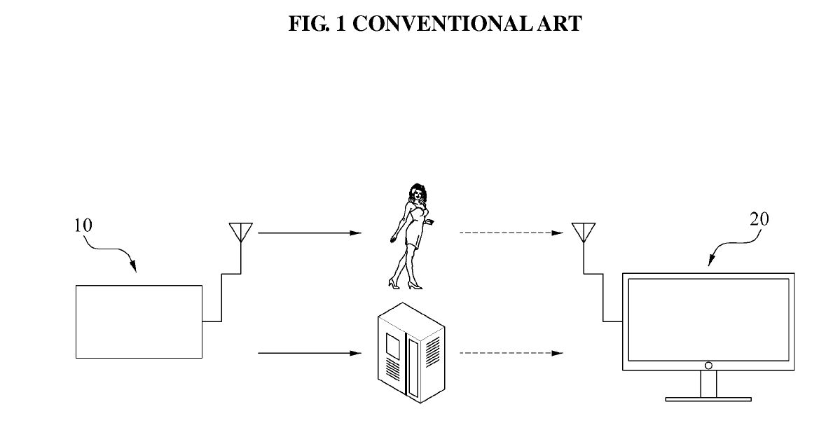

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

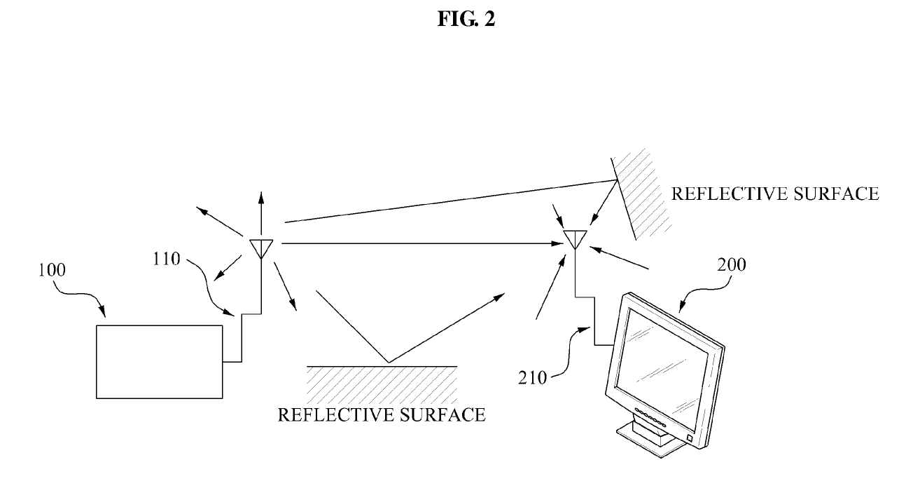

FIG. 2 illustrates an example of a process of a receiving device for receiving a millimeter waveband signal according to an embodiment of the present invention

Referring to FIG. 2, a system based on the millimeter waveband signal may include a transmitting device 100 and a receiving device 200.

The transmitting device 100 may include at least one transmission antenna, such as a transmission antenna 110, and may transmit millimeter waveband signals via a plurality of paths in response to a request.

In this case, the transmission antenna 110 may be one of an omni-directional antenna and a wide beam width antenna, and the at least one transmission antenna may be included in the transmitting device 100.

The receiving device 200 may include at least one reception antenna 210 to receive the millimeter waveband signals transmitted from the transmission antenna 110 of the transmitting device 100.

In this case, the millimeter waveband signals transmitted from the transmission antenna 110 may be transmitted to various directions via various paths and thus, the millimeter waveband signals may be directly transmitted to the reception antenna 210 or may be transmitted to the reception antenna 210 after being reflected by a reflective surface.

When a radio propagation is performed, a scale of a propagation based on a multi-path may increase or may decrease based on a phase difference between multi-path signals when the multi-path signals are combined at a receiving point. This may be referred to as a short-term fading. Generally, a communication may be disconnected in the short-term fading. The short-term fading may be incurred when various signals having phase differences are combined at the receiving point. Therefore, the short-term fading may be prevented when the signals are not combined.

According to embodiments, the transmission antenna 110 transmits the millimeter waveband signals via the plurality of paths in various directions and thus, the reception antenna 210 may receive the millimeter waveband signals via the plurality of paths. Therefore, although a portion of the plurality of paths is blocked during the transmission and the reception, signals may be reliably received via remaining paths.

To perform the above transmission/reception of the millimeter waveband signals between the transmission antenna 110 and the reception antenna 210, the receiving device 200 may include at least one reception antenna 210 receiving the plurality of millimeter waveband signals via the plurality of paths and a controller selecting a switching path from among the plurality of paths, based on the millimeter waveband signals received via the plurality of paths.

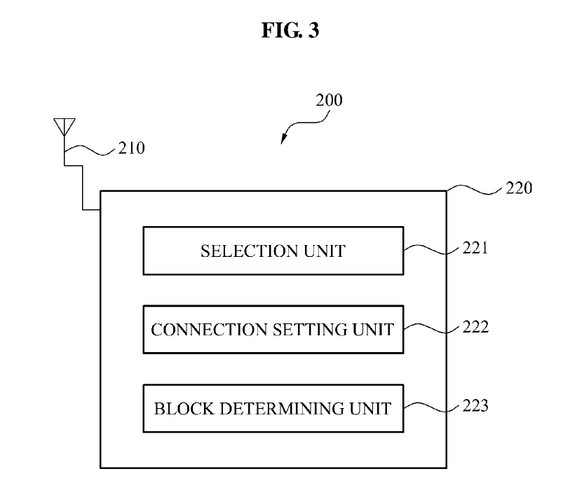

FIG. 3 illustrates a configuration of the receiving device of FIG. 2.

Referring to FIG. 3, a controller 220 may include a selection unit 221, a connection setting unit 222, and a block determining unit 223.

The selection unit 221 may check a reception level of a millimeter waveband signal for each path in the plurality of paths, and may select a switching path based on the checked reception level.

To select the switching path, the selection unit 221 may select a path corresponding to a signal having a maximum reception level or a path corresponding to a signal having a reception level greater than or equal to a predetermined level, based on the checked reception level.

The selection unit 222 may set a communication connection to the switching path selected by the selection unit 221.

The block determining unit 223 may determine whether the switching path where the communication connection is currently set is blocked.

In this case, the determining may be performed based on an existence of a received signal or based on whether a signal having a reception level less than or equal to a predetermined level is detected during a predetermined time when a reception level of the switching path is checked.

When the block determining unit determines that the switching path is blocked, the selection unit 221 may reselect another switching path, and the connection setting unit 222 may reset the communication connection to the reselected switching path.

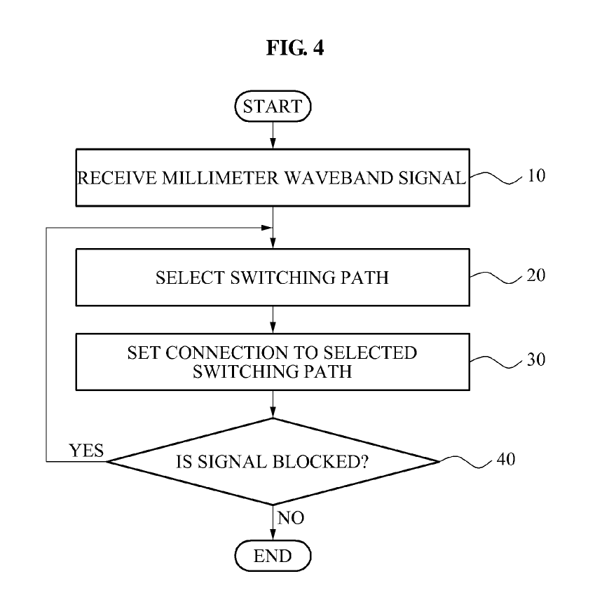

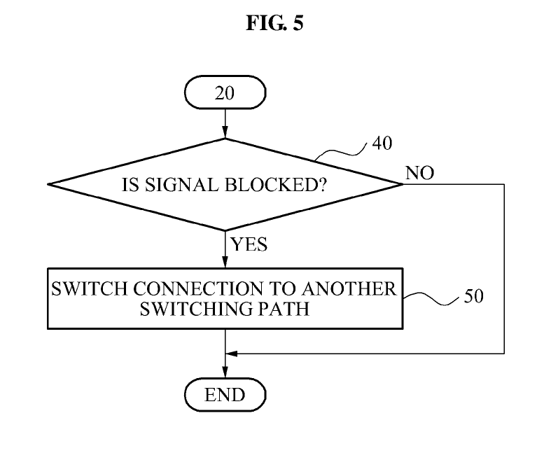

FIGS. 4 and 5 illustrate a millimeter waveband signal receiving method according to an embodiment of the present invention.

Referring to FIG. 4, a reception antenna 210 receives a plurality of millimeter waveband signals from the transmission antenna 110 via a plurality of paths in operation 10.

A switching path is selected from among the plurality of paths based on the plurality of received millimeter waveband signals in operation 20.

In this case, operation 20 may be classified into several operations as shown in FIG. 5.

Referring to FIG. 5, a reception level of a millimeter waveband signal is checked and calculated for each path in the plurality of paths, based on the plurality of received millimeter waveband signals.

A path corresponding to a signal having a maximum reception level or a path corresponding to a signal having a reception level greater than or equal to a predetermined level is selected as a switching path from among the plurality of paths, based on the calculated reception level.

In operation 30, a communication connection is set to the switching path selected in operation 20. Whether a signal in the switching path where the communication connection is currently set is blocked is determined in operation 40. When the determining in operation 40 determines that the signal in the switching path is blocked, operation 20 and operation 30 may be performed again.

When the determining in operation 40 determines that the signal in the switching path is blocked, another switching path may be selected in operation 20 and a communication connection may be reset to the other switching path in operation 30.

Therefore, although a millimeter waveband signal in a current path is suddenly blocked, a communication may be continuously maintained via another path.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A device for receiving a millimeter waveband signal, the device comprising:
at least one reception antenna to receive, from a transmission antenna, a plurality of millimeter waveband signals via a plurality of paths; and
a controller to select, based on the plurality of received millimeter waveband signals, a switching path from among the plurality of paths, to set a communication connection.

2. The device of claim 1, wherein the controller includes a selection unit to check a reception level of a millimeter waveband signal for each path in the plurality of paths, and to select the switching path based on the checked reception level.

3. The device of claim 1, wherein the controller determines whether a signal to be received via the switching path among the plurality of paths is blocked, and reselects another switching path when the determining determines the signal is blocked.

4. A method of receiving a millimeter waveband signal, the method comprising:
receiving a plurality of millimeter waveband signals via a plurality of paths;
selecting a switching path from among the plurality of paths based on the plurality of received millimeter waveband signals; and
setting a communication connection to the selected switching path.

5. The method of claim 4, wherein the selecting comprises:
checking a reception level of a millimeter waveband signal for each path in the plurality of paths; and
selecting, as the switching path, a path corresponding to a signal having a maximum reception level or a path corresponding to a signal having a reception value greater than or equal to a predetermined reception level from among the plurality of paths, based on the checked reception level.

6. The method of claim 4, further comprising:
determining whether a signal in the switching path where the communication connection is set is blocked;
reselecting another switching path among the plurality of paths based on the plurality of received millimeter waveband signals when the determining determines the signal in the switching path is blocked; and
setting a communication connection to the reselected switching path.
